(19) United States
(12) Patent Application Publication
(10) Pub. No.: US 2024/0329676 A1
(43) Pub. Date: Oct. 3, 2024

(54) POWER SUPPLY DEVICE

(71) Applicant: ROHM CO., LTD., Kyoto (JP)

(72) Inventor: Makoto YASUSAKA, Kyoto (JP)

(21) Appl. No.: 18/739,557

(22) Filed: Jun. 11, 2024

Related U.S. Application Data
(63) Continuation of application No. PCT/JP2022/037108, filed on Oct. 4, 2022.

(30) Foreign Application Priority Data
Dec. 27, 2021 (JP) 2021-211872

(51) Int. Cl. G05F 1/56

(52) U.S. Cl. CPC G05F 1/56

(57) ABSTRACT

A power supply device includes: an input terminal configured to receive an input voltage; an output terminal configured to have an output voltage applied to it; a power terminal configured to receive a supply voltage; an output transistor provided between the power terminal and the output terminal; a level shifter configured to generate two comparison voltages by shifting the levels of the input voltage and the output voltage to lower potentials; and an amplifier circuit configured to control the state of the output transistor based on the magnitude relationship between the two comparison voltages.

### CROSS-REFERENCE TO RELATED APPLICATIONS

This nonprovisional application is a continuation application of International Patent Application No. PCT/JP2022/037108 filed on Oct. 4, 2022, which claims priority Japanese Patent Application No. 2021-211872 filed on Dec. 27, 2021, the entire contents of which are hereby incorporated by reference.

### TECHNICAL FIELD

The present disclosure relates to power supply devices.

### BACKGROUND ART

Some known power supply devices (e.g., voltage trackers) adjust an output voltage by controlling the state of an output transistor according to an input voltage and the output voltage. This type of power supply device employs an amplifier circuit to compare the input voltage and the output voltage.

### CITATION LIST

### Patent Literature

Patent Document 1: JP-A-2016-189728

### BRIEF DESCRIPTION OF DRAWINGS

FIG. 1 is a block diagram of a device according to a first reference configuration.

FIG. 2 is a block diagram of a device according to a second reference configuration.

FIG. 3 is a configuration diagram of a voltage tracker according to the second reference configuration.

FIG. 4 is a circuit diagram of an error amplifier included in the voltage tracker according to the second reference configuration.

FIG. 5 is a diagram showing the sectional structure of an ordinary MOSFET.

FIG. 6 is a diagram showing the sectional structure of a DMOSFET.

FIG. 7 is a configuration diagram of a voltage tracker according to an embodiment (contrived configuration) of the present disclosure.

FIG. 8 is a schematic exterior view of the voltage tracker according to the embodiment of the present disclosure.

FIG. 9 is a diagram showing the voltage tracker according to the embodiment of the present disclosure implemented on a circuit board.

FIG. 10 is a circuit diagram of an error amplifier included in the voltage tracker according to the embodiment of the present disclosure.

FIG. 11 is a circuit diagram of a voltage tracker according to a first practical example belonging to the embodiment of the present disclosure.

FIG. 12 is a circuit diagram of a voltage tracker according to a second practical example belonging to the embodiment of the present disclosure.

FIG. 13 is a circuit diagram of a voltage tracker according to a third practical example belonging to the embodiment of the present disclosure.

FIG. 14 is a circuit diagram of a voltage tracker according to a fourth practical example belonging to the embodiment of the present disclosure.

FIG. 15 is a circuit diagram of a voltage tracker according to a fifth practical example belonging to the embodiment of the present disclosure.

FIG. 16 is a circuit diagram of a voltage tracker according to a sixth practical example belonging to the embodiment of the present disclosure.

### DESCRIPTION OF EMBODIMENTS

Prior to a description of embodiments of the present disclosure, some reference configurations will be described.

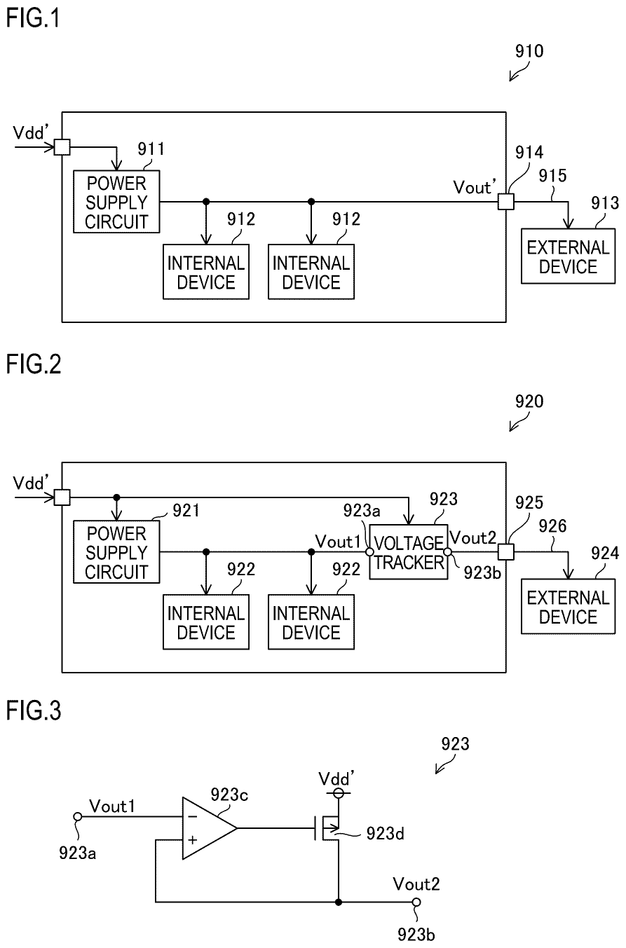

FIG. 1 is a block diagram of a device 910 according to a first reference configuration. In the device 910, a power supply circuit 911 generates from an original voltage Vdd′ an output voltage Vout′ and feeds the output voltage Vout′ as a supply voltage to an internal device 912. On the other hand, the supply voltage (Vout′) for the internal device 912 is also fed via a connector 914 and a wiring 915 to an external device 913. In the device 910, if an extraneous disturbance such as a static electrical charge or a surge is applied to the connector 914 or the wiring 915, the extraneous disturbance influences the internal device 912. Also if a faut such as a ground short circuit or a supply short circuit occurs at the connector 914, it influences the internal device 912.

FIG. 2 is a block diagram of a device 920 according to a second reference configuration, which can suppress the influence of events as mentioned above. In the device 920, a power supply circuit 921 generates from an original voltage Vdd′ an output voltage Vout1 and feeds the output voltage Vout1 as a supply voltage to an internal device 922. The device 920 includes a voltage tracker 923 that operates based on the original voltage Vdd′. The voltage tracker 923 has an input terminal 923a and an output terminal 923b. The voltage tracker 923 receives the output voltage Vout1 at the input terminal 923a and outputs, from the output terminal 923b, an output voltage Vout2 with the same voltage value as the output voltage Vout1. The output voltage Vout2 is fed via a connector 925 and a wiring 926 to an external device 924.

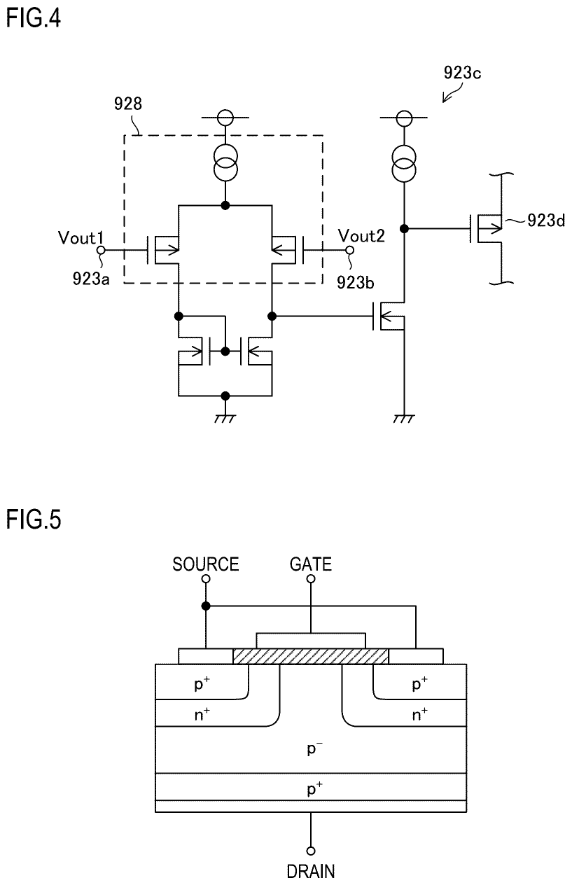

As shown in FIG. 3, the voltage tracker 923 has an error amplifier 923c and an output transistor 923d. The error amplifier 923c is fed with the voltages Vout1 and Vout2. The error amplifier 923c, based on the result of comparison between the voltages Vout1 and Vout2, controls the gate voltage of the output transistor 923d and thereby keeps the voltages Vout1 and Vout2 equal. Using the voltage tracker 923 like this makes it possible to supply the external device 924 with necessary electric power while suppressing the internal device 922 being influenced in the event of an external disturbance applied to the connector 925 or the wiring 926 or a fault such as a ground short circuit or a supply short circuit occurring at the connector 925. FIG. 4 shows an example of the internal circuit of the error amplifier 923c.

Voltage trackers have conventionally been required to perform their tracking function in relatively low voltage ranges. Today, however, demand is increasing for voltage trackers that can handle high voltages. With the second reference configuration shown in FIGS. 2 and 3, handling a wide range of voltages requires raising the withstand voltage of the circuit in the input stage of the error amplifier 923c (corresponding to the circuit surrounded by a broken line 928 in FIG. 4). Simply raising the withstand voltage of the MOSFETs (corresponding to ordinary MOSFETs discussed later) in that circuit leads to a larger implementation area of the error amplifier 923c, and this prevents area-saving in the voltage tracker. Also required is a production line that can fabricate high-withstand voltage MOSFETs (corresponding to ordinary MOSFETs discussed later), and if no such production line is at hand, one needs to be installed newly.

DMOSFETs are known to be elements that are suited for adaptation to higher withstand voltages and for space-saving. Inconveniently, while DMOSFETs permit easy raising of the withstand voltage for the drain-source voltage, their withstand voltage for the gate voltage is basically as low as that of common low-withstand-voltage elements. For this reason, in the configuration of an ordinary amplifier circuit (in the circuit of the error amplifier 932c in FIG. 4), using DMOSFETs as they are does not provide the required withstand voltage.

Examples of implementing the present disclosure with the circumstances discussed above taken into consideration will now be described specifically with reference to the accompanying drawings. Among the diagrams referred to in the course, the same parts are identified by the same reference signs, and in principle no overlapping description of the same parts will be repeated. In the present description, for the sake of simplicity, symbols and reference signs referring to information, signals, physical quantities, elements, parts, and the like are occasionally used with omission or abbreviation of the names of the information, signals, physical quantities, elements, parts, and the like corresponding to those symbols and reference signs. For example, the output transistor described later and identified by the reference sign “M0” (see FIG. 7) is sometimes referred to as “output transistor M0” and other times abbreviated to “transistor M0”, both referring to the same entity.

First, some of the terms used to describe embodiments of the present disclosure will be defined. “Ground” denotes a reference conductor at a reference potential of 0 V (zero volts), or to a potential of 0 V itself. A reference conductor is formed of an electrically conductive material such as metal. A potential of 0 V is occasionally referred to as a ground potential. In embodiments of the present disclosure, any voltage mentioned with no particular reference mentioned is a potential relative to the ground. “Level” denotes the level of a potential.

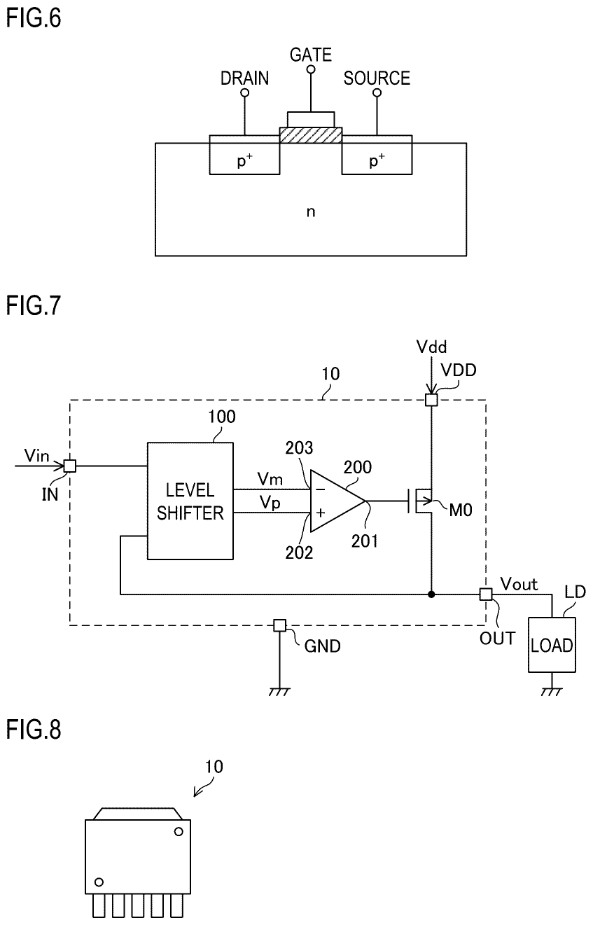

“MOSFET” is an abbreviation of “metal-oxide-semiconductor field-effect transistor”. Unless otherwise stated, any MOSFET can be understood to be an enhancement MOSFET. Unless otherwise stated, for any MOSFET, its back gate is understood to be short-circuited to its source. “DMOSFET” denotes a type of MOSFET and is an abbreviation of “double-diffused metal-oxide-semiconductor field-effect transistor”. In the present description, “ordinary MOSFET” denotes a MOSFET with a different structure from a DMOSFET. FIG. 5 shows an example of a schematic sectional structure of a P-channel DMOSFET and FIG. 6 shows an example of a schematic sectional structure of an ordinary MOSFET. In a DMOSFET, the source and the drain are located apart from each other along a direction orthogonal to the surface of a semiconductor substrate. By contrast, in an ordinary MOSFET, the source and the drain are located apart from each other along a direction parallel to the surface of a semiconductor substrate (the source and the drain are formed on the same surface of the semiconductor substrate). While any MOSFET mentioned in the following description can be either an ordinary MOSFET or a DMOSFET, some MOSFETs will be distinguished as either an ordinary MOSFET or a DMOSFET as necessary.

Unless otherwise stated, wherever “connection” is discussed among a plurality of parts constituting a circuit, as among given circuit elements, wirings, nodes, and the like, the term is to be understood to denote “electrical connection”.

### <<Contrived Configuration>>

A contrived configuration according to an embodiment of the present disclosure will be described. FIG. 7 is a schematic configuration diagram of a voltage tracker 10 according to the contrived configuration. The voltage tracker 10 is a kind of power supply device. FIG. 8 is an exterior view of the voltage tracker 10.

The voltage tracker 10 is an electronic component that includes a semiconductor chip having a semiconductor integrated circuit or semiconductor elements formed on a semiconductor substrate, a package (case) housing the semiconductor chip, and a plurality of external terminals exposed out of the package to outside the voltage tracker 10. Sealing the semiconductor chip in the package (case) formed of resin yields the voltage tracker 10. The number of external terminals, and the type of package, of the voltage tracker 10 shown in FIG. 2 are merely illustrative, and can be designed as desired. FIG. 1 shows, as four of the plurality of external terminals mentioned above, a power terminal VDD, an input terminal IN, an output terminal OUT, and a ground terminal GND. The voltage tracker 10 can have any external terminals other than those just mentioned.

The voltage tracker 10 includes a level shifter 100, an error amplifier 200, and an output transistor M0. The level shifter 100, the error amplifier 200, and the output transistor M0 are provided on a single semiconductor chip, or are provided on a plurality of semiconductor chips, distributed among these. The voltage tracker 10 also includes, though not illustrated, an overcurrent protection circuit, a thermal shut-down circuit, and the like.

The input terminal IN is a voltage input terminal for receiving an input voltage Vin, and the output terminal OUT is a voltage output terminal for delivering an output voltage Vout. Accordingly, the input terminal IN is fed with the input voltage Vin and the output terminal OUT has the output voltage Vout applied to it. The power terminal VDD is a supply input terminal for receiving a supply voltage Vdd. Accordingly, the power terminal VDD is fed with the supply voltage Vdd. The ground terminal GND is connected to a ground at a reference potential of 0 V.

The input voltage Vin, the output voltage Vout, and the supply voltage Vdd are positive voltages. The input voltage Vin, while it can vary, basically is a positive direct-current voltage; in the following description, unless otherwise stated, the input voltage Vin is assumed to have a predetermined positive direct-current voltage value. The supply voltage Vdd, while it can vary, basically is a positive direct-current voltage; in the following description, unless otherwise stated, the supply voltage Vdd is assumed to have a predetermined positive direct-current voltage value. The supply voltage Vdd is higher than the input voltage Vin.

All the circuits in the voltage tracker 10 operate from the supply voltage Vdd. The elements constituting the voltage tracker 10 are given withstand voltages sufficient not to break down or otherwise fail so long as the input voltage Vin and the supply voltage Vdd have voltage values that fall within prescribed specifications.

The output transistor M0 is provided between the power terminal VDD and the output terminal OUT. Here, the output transistor M0 is assumed to be configured as a P-channel MOSFET. The source of the output transistor M0 is connected to the power terminal VDD, and the drain of the output transistor M0 is connected to the output terminal OUT. Outside the voltage tracker 10, the output terminal OUT has a load LD connected to it. The load LD is any load that operates based on the output voltage Vout. The load LD is provided between the output terminal OUT and the ground, and draws in a current from the output terminal OUT. The output terminal OUT can have connected to it one load or two or more loads.

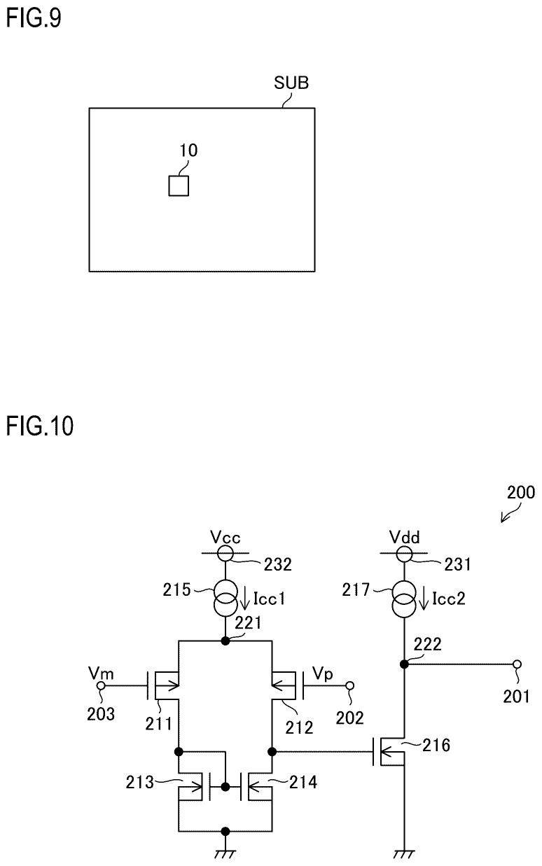

As shown in FIG. 9, the voltage tracker 10 is implemented on a substrate SUB which is a printed circuit board. The whole or part of the load LD can be implemented on the substrate SUB. Or the whole or part of the load LD can, instead of being implemented on the substrate SUB, be connected to the output terminal OUT via a connector and a cable. Or the whole or part of the load LD can be implemented on a substrate (not illustrated) separate from the substrate SUB. The voltage tracker 10 has a current supply capacity sufficient to supply the load LD with the current it needs.

The voltage tracker 10 operates so as to keep the output voltage Vout equal to the input voltage Vin. The error amplifier 200 includes an output terminal 201, a non-inverting input terminal 202, and an inverting input terminal 203. The output terminal 201 of the error amplifier 200 is connected to the gate of the output transistor M0, and the error amplifier 200 controls the gate potential of the output transistor M0 so as to keep the output voltage Vout equal to the input voltage Vin.

Here, unlike in the second reference configuration (see FIGS. 2 and 3) described previously, the voltage tracker 10 has the level shifter 100 inserted between, at one end, the input terminal IN and the output terminal OUT and, at the other end, the error amplifier 200. The level shifter 100 shifts the input voltage Vin and the output voltage Vout to lower potentials and thereby generates two comparison voltages. The two comparison voltages so generated are voltages lower than the input voltage Vin and the output voltage Vout. Of these two comparison voltages, one is fed to the non-inverting input terminal 202 of the error amplifier 200 and the other is fed to the inverting input terminal 203 of the error amplifier 200. The comparison voltage fed to the non-inverting input terminal 202 will be identified by the symbol “Vp” and the comparison voltage fed to the inverting input terminal 203 will be identified by the symbol “Vm”.

Based on the magnitude relationship between the two comparison voltages, the error amplifier 200 controls the gate voltage of the output transistor M0 and thereby controls the state of the output transistor M0 so as to keep the output voltage Vout equal to the input voltage Vin. Keeping the output voltage Vout equal to the input voltage Vin means, in other words, keeping the difference between the output voltage Vout and the input voltage Vin zero, or reducing the difference between the output voltage Vout and the input voltage Vin so as to make it close to zero. The output voltage Vout being equal to the input voltage Vin means, more specifically, that the voltage value of the output voltage Vout is equal to the voltage value of the input voltage Vin.

If Vout>Vin (i.e., if the output voltage Vout is higher than the input voltage Vin), the level shifter 100 generates the two comparison voltages mentioned above such that “Vp>Vm”. The error amplifier 200 then raises the gate potential of the output transistor M0 to reduce the current that passes from the power terminal VDD via the output terminal OUT, and consequently the output voltage Vout falls. By contrast, if Vout<Vin (i.e., if the output voltage Vout is lower than the input voltage Vin), the level shifter 100 generates the two comparison voltages mentioned above such that “Vp<Vm”. The error amplifier 200 then lowers the gate potential of the output transistor M0 to increase the current that passes from the power terminal VDD via the output terminal OUT, and consequently the output voltage Vout rises. Through this operation, the output voltage Vout is kept at a voltage generally equal to the input voltage Vin.

FIG. 10 shows an example of the circuit of the error amplifier 200. The error amplifier 200 in FIG. 10 includes transistors 211 to 214 and 216 and constant current sources 215 and 217. The transistors 211 and 212 are P-channel MOSFETs. The transistors 213, 214, and 216 are N-channel MOSFETs.

In FIG. 10, a terminal 231 is fed with the supply voltage Vdd and a terminal 232 is fed with an internal supply voltage Vcc. The voltage tracker 10 includes an internal power supply circuit (not illustrated) that generates and outputs the internal supply voltage Vcc based on the supply voltage Vdd. The internal supply voltage Vcc is lower than the supply voltage Vdd. For example, the supply voltage Vdd is 40 V or higher and the internal supply voltage Vcc is 5 V.

The constant current source 215 generates a constant current Icc1 based on the internal supply voltage Vcc and supplies the constant current Icc1 from the terminal 232 toward a node 221. The sources of the transistors 211 and 212 are connected together at the node 221. The drain of the transistor 211 is connected to the drain and the gate of the transistor 213 and to the gate of the transistor 214. The sources of the transistors 213 and 214 are connected to the ground. The drain of the transistor 212 is connected to the drain of the transistor 214 and to the gate of the transistor 216.

The constant current source 217 generates a constant current Icc2 based on the supply voltage Vdd and supplies the constant current Icc2 from the terminal 231 toward a node 222. The node 222 is connected to the drain of the transistor 216 and is connected also to the output terminal 201 of the error amplifier 200. The source of the transistor 216 is connected to the ground. The gate of the transistor 211 is connected to the inverting input terminal 203 of the error amplifier 200 to be fed with the comparison voltage Vm. The gate of the transistor 212 is connected to the non-inverting input terminal 202 of the error amplifier 200 to be fed with the comparison voltage Vp.

The voltage tracker 10 can handle a wide voltage range Vrng from low to high voltages. That is, so long as the input voltage Vin has a voltage value within the voltage range Vrng, the voltage tracker 10 is guaranteed to operate normally, carrying out, among others, control to keep the output voltage Vout equal to the input voltage Vin. Here, a low voltage refers to a relatively low voltage like a voltage of about 1 V and a high voltage refers to a relatively high voltage like a voltage of about 40 V. In the following description, the voltage range Vrng is assumed to be a voltage range from a predetermined input lower-limit voltage V_{LL} (e.g., 1 V) to a predetermined input upper-limit voltage V_{HH} (e.g., 40 V) higher than the input lower-limit voltage V_{LL}. So long as the input voltage Vin has a voltage value within the voltage range Vrng, the level shifter 100 converts the input voltage Vin into one of the comparison voltages Vm and Vp and converts the output voltage Vout into the other of the comparison voltages Vm and Vp. This enables control to keep the output voltage Vout equal to the input voltage Vin.

The comparison voltages Vm and Vp are set to be voltages within a range that low-withstand-voltage elements can handle. This helps reduce the size of the circuit (save the area of the circuit implemented as a semiconductor integrated circuit). That is, in comparison with a configuration that simply raises the withstand voltage of the circuit surrounded by the broken line 928 in the second reference configuration, it is possible to reduce the circuit area of the voltage tracker. In fact, in the error amplifier 200 in FIG. 10, the transistors 211 to 214 can be configured as ordinary MOSFETs as low-withstand-voltage elements, and also the current source 215, though not illustrated, can be configured as an ordinary MOSFET as a low-withstand-voltage element. Moreover, the wide voltage range Vrng can be achieved with no change in the existing production process (the circuit can be fabricated by the existing production process).

In this embodiment, a low-withstand-voltage element refers to a MOSFET of which the withstand voltage for the drain-source voltage is relatively low as compared with a high-withstand-voltage element; a high-withstand-voltage element refers to a MOSFET of which the withstand voltage for the drain-source voltage is relatively high as compared with a low-withstand-voltage element. Specifically, suppose, in a low-withstand-voltage element, the withstand voltage for the drain-source voltage is a first voltage V_{XL} and, in a high-withstand-voltage element, the withstand voltage for the drain-source voltage is a second voltage V_{XH}, then the second voltage V_{XH} is higher than the first voltage V_{XL}. Here, the first voltage V_{XL} (e.g., 5 V) is lower than the input upper-limit voltage V_{HH} (e.g. 40 V) and the second voltage V_{XH} (e.g., 50 V) is higher than the input upper-limit voltage V_{HH} (e.g., 40 V).

Specific examples of the circuit and operation of the voltage tracker 10 will be described below by way of a plurality of practical examples, along with applied or modified technologies and the like. Unless otherwise stated or unless inconsistent, any features of the voltage tracker 10 described in connection with the embodiment above are applicable to the practical examples described below. For any features of the practical examples that contradict with what has been described above, their description given in connection with the practical examples can prevail. Unless inconsistent, any feature of any of the plurality of practical examples described below is applicable to any other of the practical examples (i.e., two or more of the plurality of practical examples can be implemented in combination).

### First Practical Example

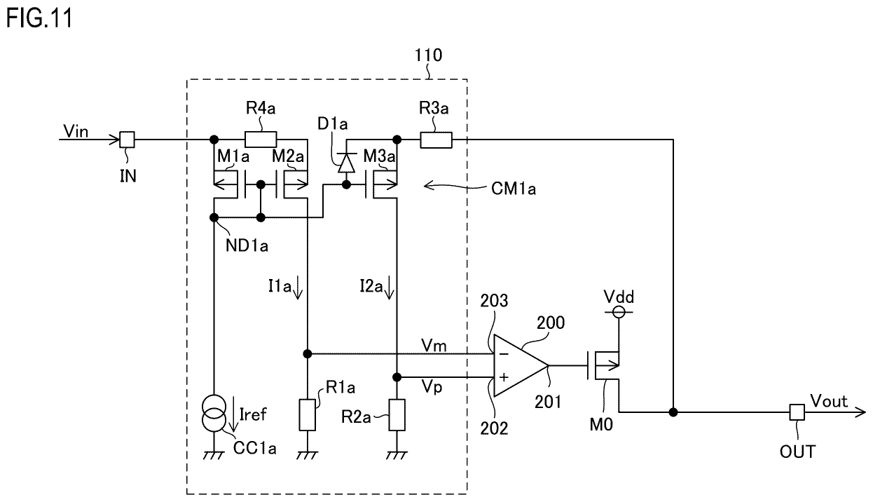

A first practical example according to the present disclosure will be described. FIG. 11 is a circuit diagram of a voltage tracker 10 according to the first practical example. In the first practical example, as the level shifter 100 shown in FIG. 7, a level shifter 110 as shown in FIG. 11 is used.

The level shifter 110 includes transistors M1a to M3a, resistors R1a to R4a, a diode D1a, and a constant current source CC1a. The transistors M1a to M3a are high-withstand-voltage elements and are configured as P-channel DMOSFETs.

The interconnections among the circuit elements of the level shifter 110 will be described. To the input terminal IN, the source of the transistor M1a and one terminal of the resistor R4a are both connected. The other terminal of the resistor R4a is connected to the source of the transistor M2a. Thus, the resistor R4a is disposed between the source of the transistor M1a and the source of the transistor M2a. The gate and the drain of the transistor M1a, the gate of the transistor M2a, the gate of the transistor M3a, and the anode of the diode D1a are all connected to a node ND1a. The constant current source CC1a is provided between the node ND1a and the ground. The drain of the transistor M2a is connected to one terminal of the resistor Ria and to the inverting input terminal 203 of the error amplifier 200. The other terminal of the resistor Ria is connected to the ground. The drain of the transistor M3a is connected to one terminal of the resistor R2a and to the non-inverting input terminal 202 of the error amplifier 200, and the other terminal of the resistor R2a is connected to the ground. The source of the transistor M3a and the cathode of the diode D1a are connected to one terminal of the resistor R3a. The other terminal of the resistor R3a is connected to the output terminal OUT.

The operation of the level shifter 110, the characteristics of the individual elements in it, and the like will be described. The constant current source CC1a operates to generate a constant current Iref and pass the constant current Iref from the node ND1a toward the ground. The constant current Iref has a predetermined fixed current value. The constant current Iref corresponds to the drain current of the transistor M1a.

The resistors R1a and R2a are resistors of the same type and have the same resistance values. The resistors R3a and R4a are resistors of the same type and have the same resistance values.

The transistors M1a to M3a constitute a current mirror circuit CM1a. The current mirror circuit CM1a has the transistor M1a disposed in the current input side and has the transistors M2a and M3a disposed in the current output side. The constant current Iref functions as the reference current in the current mirror circuit CM1a and the constant current source CC1a functions as a current source that supplies the reference current to the transistor M1a. In each of the transistors M1a, M2a, and M3a, a current corresponding to the gate-source voltage (the gate potential relative to the source potential) passes between the source and the drain.

The drain current of the transistor M2a is represented by the symbol “I1a” and the drain current of the transistor M3a is represented by the symbol “I2a”. The currents I1a and I2a can be called a first mirror current and a second mirror current respectively. The current mirror circuit CM1a produces, in the transistors M2a and M3a, the first and second mirror currents (T1a and T2a) corresponding to the reference current (Tref) passing through the transistor M1a.

The resistors R1a and R2a function as elements for converting the currents I1a and I2a into voltages. The current I1a passing through the resistor R1a produces across the resistor R1a a voltage drop that functions as the comparison voltage Vm. The current I2a passing through the resistor R2a produces across the resistor R2a a voltage drop that functions as the comparison voltage Vp.

The current mirror circuit CM1a is so configured that a current corresponding to the drain current (Iref) of the transistor M1a passes as the drain current I1a of the transistor M2a and that a current corresponding to the drain current (Iref) of the transistor M1a passes as the drain current I2a of the transistor M3a. On the assumption (for convenience' sake hereinafter referred to as the first assumption) that the resistance values of the resistors R3a and R4a are zero and no current is passing through the diode D1a, the currents I1a and I2a are each a current that is proportional to the drain current (Iref) of the transistor M1a.

Here, it is assumed that the transistors M1a to M3a are transistors that are formed on the same semiconductor substrate by the same production process and that have the same structure so that the transistors M1a to M3a have the same electric characteristics. Then, under the first assumption mentioned above, if Vout=Vin, the gate-source voltages of the transistors M1a, M2a, and M3a are equal, and thus the magnitudes of the drain currents of the transistors M1a, M2a, and M3a are equal (specifically, Iref=I1a=I2a). In this condition, the comparison voltage Vm, which corresponds to the voltage drop across the resistor R1a, and the comparison voltage Vp, which corresponds to the voltage drop across the resistor R2a, are equal.

When the output voltage Vout rises to be higher than the input voltage Vin, the source potential of the transistor M3a rises and the drain current I2a increases; thus the comparison voltage Vp rises. As a result, the gate potential of the output transistor M0 rises and the drain current of the output transistor M0 decreases; thus the output voltage Vout changes in the decreasing direction. By contrast, when the output voltage Vout falls to be lower than the input voltage Vin, the source potential of the transistor M3a falls and the drain current I2a decreases; thus the comparison voltage Vp falls. As a result, the gate potential of the output transistor M0 falls and the drain current of the output transistor M0 increases; thus the output voltage Vout changes in the increasing direction. A similar description applies to the case where the input voltage Vin has changed until the magnitude relationship between the input voltage Vin and the output voltage Vout is reversed. Through the operation described above, the output voltage Vout is kept at a value generally equal to the value of the input voltage Vin,

The values of the constant current Iref and the resistors R1a and R2a are designed such that the voltage (Vm) appearing across the resistor R1a and the voltage (Vp) appearing across the resistor R2a do not exceed the withstand voltage of low-withstand-voltage elements. Thus the error amplifier 200 can employ a circuit configured with low-withstand-voltage elements, and this helps achieve an effect of area saving.

The diode D1a and the resistor R3a are elements for protecting the gate voltage of the transistor M3a. When the voltage tracker 10 starts up or has an output short circuit, the output voltage Vout becomes considerably lower than the input voltage Vin (e.g., with the input voltage Vin at 40 V and the output voltage Vout at 0 V). In this condition, if the diode D1a is not provided, the gate-source voltage of the transistor M3a can exceed the rated voltage. This is avoided by the provision of the diode D1a and the resistor R3a.

With the resistor R3a provided, the source potential of the transistor M3a is lower than the output voltage Vout by the voltage drop across the resistor R3a. The voltage drop across the resistor R3a acts as an offset voltage that has to be eliminated to achieve Vout=Vin. To cancel this offset voltage, the resistor R4a with the same resistance value as the resistor R3a is provided at the source side of the transistor M2a. Though not specifically illustrated, a resistor of the same type as and with the same resistance value as the resistors R3a and R4a can be inserted between the connection node between the input terminal IN and the resistor R4a and the source of the transistor M1a.

The source area ratio of the transistors M1a, M2a, and M3a can be designed such that, under the first assumption mentioned above, if Vout=Vin, Iref<I1a=I2a or Iref>I1a=I2a.

### Second Practical Example

A second practical example according to the present disclosure will be described. The gate threshold voltages of DMOSFETs vary relatively greatly. Specifically, even when a plurality of DMOSFETs are fabricated with the aim of giving them identical electrical characteristics, their gate threshold voltages may vary relatively greatly. Variations in gate threshold voltage among the transistors M1a to M3a act as an error factor in the control to keep the output voltage Vout equal to the input voltage Vin. With this taken into consideration, in the configuration of the first practical example (FIG. 11), the transistors M1a to M3a can be configured as low-withstand-voltage ordinary MOSFETs (ordinary MOSFETs as low-withstand-voltage elements). In that case, however, an additional alteration is necessary to prevent a high voltage (specifically, a voltage exceeding the first voltage V_{XL}, which is the withstand voltage of low-withstand-voltage elements) from being applied between the source and drain of the transistors M1a to M3a. A voltage tracker 10 in which that alteration has been made will now be described as a second practical example.

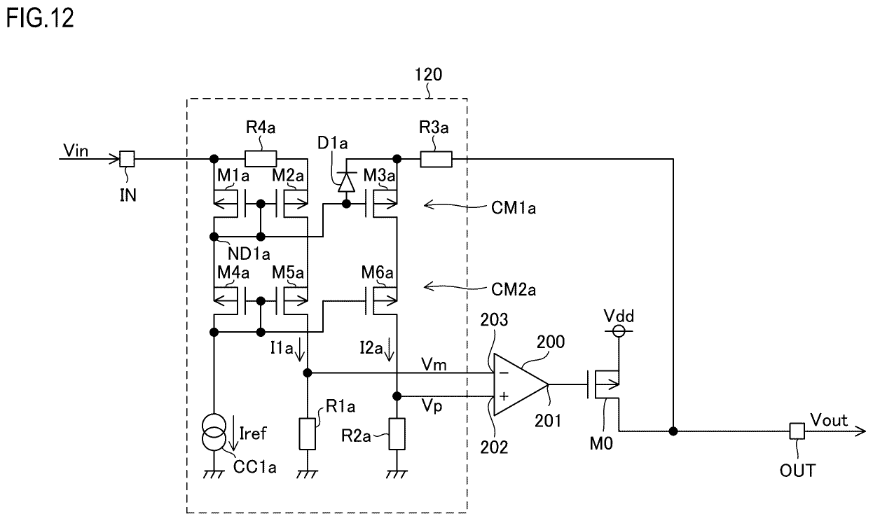

FIG. 12 is a circuit diagram of the voltage tracker 10 according to the second practical example. In the second practical example, as the level shifter 100 shown in FIG. 7, a level shifter 120 as shown in FIG. 12 is used.

The level shifter 120 is configured to further include, as compared with the level shifter 110 in the first practical example, transistors M4a to M6a. Moreover, in the level shifter 120, the transistors M1a to M3a are configured as low-withstand-voltage ordinary MOSFETs (ordinary MOSFETs as low-withstand-voltage elements). These differences apart, the level shifter 120 has the same configuration as the level shifter 110. Accordingly, for any features not specifically described in connection with the second practical example, the corresponding description of the level shifter 110 given in connection with the first practical example can apply to the level shifter 120.

In the level shifter 120, whereas the transistors M1a to M3a are low-withstand-voltage elements and are configured as P-channel ordinary MOSFETs, the transistors M4a to M6a are high-withstand-voltage elements and are configured as P-channel DMOSFETs. In the level shifter 120, the transistor M4a is provided between the transistor M1a and the constant current source CC1a, the transistor M5a is provided between the transistor M2a and the resistor R1a, and the transistor M6a is provided between the transistor M3a and the resistor R2a.

Specifically, in the level shifter 120, the source of the transistor M4a is connected to the drain of the transistor M1a (hence connected to the node ND1a) and, between the drain of the transistor M4a and the ground, the constant current source CC1a is provided. In the level shifter 120, the source of the transistor M5a is connected to the drain of the transistor M2a and the drain of the transistor M5a is connected to the inverting input terminal 203 of the error amplifier 200 and to one terminal of the resistor R1a. The other terminal of the resistor R1a is connected to the ground. In the level shifter 120, the source of the transistor M6a is connected to the drain of the transistor M3a, and the drain of the transistor M6a is connected to the non-inverting input terminal 202 of the error amplifier 200 and to one terminal of the resistor R2a. The other terminal of the resistor R2a is connected to the ground.

In the level shifter 120, the drain and the gate of the transistor M4a, the gate of the transistor M5a, and the gate of the transistor M6a are connected together. Thus the transistors M4a to M6a constitute a current mirror circuit CM2a. The current mirror circuit CM2a has the transistor M4a disposed in the current input side, and has the transistors M5a and M6a disposed in the current output side.

The constant current Iref (reference current) produced by the constant current source CC1a passes through the transistors M1a and M4a as the drain currents of the transistors M1a and M4a. The current I1a that passes through the resistor R1a passes through the transistors M2a and M5a as the drain currents of the transistors M2a and M5a. The current I2a that passes through the resistor R2a passes through the transistors M3a and M6a as the drain currents of the transistors M3a and M6a.

Preferably, the transistors M1a to M3a are formed on the same semiconductor substrate by the same production process and have the same structure so that the transistors M1a to M3a have the same electrical characteristics. Likewise, the transistors M4a to M6a are formed on the same semiconductor substrate by the same production process and have the same structure so that the transistors M4a to M6a have the same electrical characteristics.

In the level shifter 120, owing to the transistors M1a to M3a being configured as low-withstand-voltage ordinary MOSFETs, variations in gate threshold voltage among the transistors M1a to M3a are smaller than when they are configured as DMOSFETs. This helps reduce the error factor for the control to keep the output voltage Vout equal to the input voltage Vin. Even if a high input voltage Vin (e.g., 40 V) is applied to the input terminal IN, the large part of the voltage can be born between the drain and the source of the transistors M4a to M6a configured as DMOSFETs, and thus no problem results.

### Third Practical Example

A third practical example according to the present disclosure will be described. In the voltage tracker 10 according to the first practical example, if elements with a sufficiently high withstand voltage for their gate voltage can be used as the transistors M1a to M3a, those transistors can be used as the transistors M1a to M3a. In that case, no protection is needed for the gate voltage, and thus the diode D1a and the resistors R3a and R4a can be omitted.

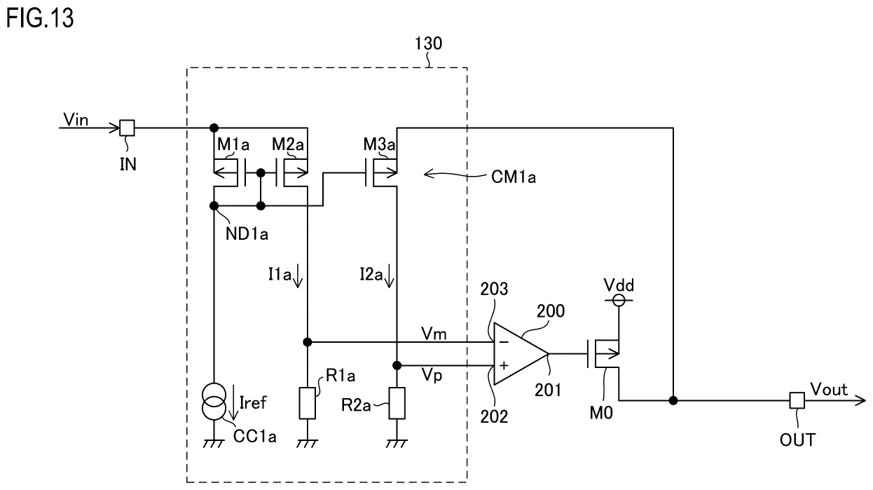

Specifically, the level shifter 110 in the first practical example can be modified to a level shifter 130 as shown in FIG. 13. FIG. 13 is a circuit diagram of a voltage tracker 10 according to the third practical example. In the third practical example, as the level shifter 100 shown in FIG. 7, the level shifter 130 shown in FIG. 13 is used.

Omitting the diode D1a and the resistors R3a and R4a from the level shifter 110 according to the first practical example yields the level shifter 130. The omission necessitates the source of the transistor M2a being directly connected to the input terminal IN and the source of the transistor M3a being directly connected to the output terminal OUT in the level shifter 130. Apart from the omission mentioned above, the level shifter 130 has the same configuration as the level shifter 110. Accordingly, for any features not specifically described in connection with the third practical example, the corresponding description of the level shifter 110 given in connection with the first practical example can apply to the level shifter 130.

Note however that, in the level shifter 130, elements with a sufficiently high withstand voltage for the gate voltage are used as the transistors M1a to M3a. Specifically, P-channel MOSFETs with a withstand voltage exceeding the input upper-limit voltage V_{HH} as their withstand voltage for the gate-source voltage are used as the transistors M1a to M3a in the level shifter 130. So long as a withstand voltage as just mentioned is obtained, in the level shifter 130, the transistors M1a to M3a can be implemented with ordinary MOSFETs or DMOSFETs.

Also with the level shifter 130, it is possible to keep the comparison voltages Vm and Vp sufficiently low; it is thus possible to achieve an effect of area reduction similar to that in the first practical example.

### Fourth Practical Example

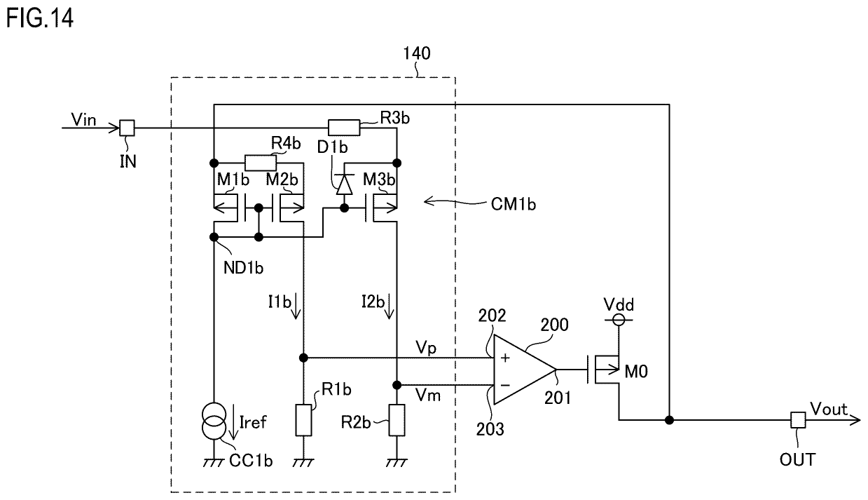

A fourth practical example according to the present disclosure will be described. In the configuration of the first practical example (see FIG. 11), the part connected to the input terminal IN and the part connected to the output terminal OUT can be reversed (see FIG. 14). Note however that doing so requires an additional alteration such as reversing the polarities of the error amplifier 200 as compared with the first practical example. This will now be described as the fourth practical example.

FIG. 14 is a circuit diagram of a voltage tracker 10 according to the fourth practical example. In the fourth practical example, as the level shifter 100 shown in FIG. 7, a level shifter 140 as shown in FIG. 14 is used.

The level shifter 140 includes transistors M1b to M3b, resistors Rib to R4b, a diode Dib, and a constant current source CC1b. The transistors M1b to M3b are high-withstand-voltage elements and are configured as P-channel DMOSFETs.

The interconnections among the circuit elements of the level shifter 140 will be described. To the output terminal OUT, the source of the transistor M1b and one terminal of the resistor R4b are both connected. The other terminal of the resistor R4b is connected to the source of the transistor M2b. Thus, the resistor R4b is disposed between the source of the transistor M1b and the source of the transistor M2b. The gate and the drain of the transistor M1b, the gate of the transistor M2b, the gate of the transistor M3b, and the anode of the diode Dib are all connected to a node ND1b. The constant current source CC1b is provided between the node ND1b and the ground. The drain of the transistor M2b is connected to one terminal of the resistor Rib and to the non-inverting input terminal 202 of the error amplifier 200, and the other terminal of the resistor Rib is connected to the ground. The drain of the transistor M3b is connected to one terminal of the resistor R2b and to the inverting input terminal 203 of the error amplifier 200, and the other terminal of the resistor R2b is connected to the ground. The source of the transistor M3b and the cathode of the diode Dib are connected to one terminal of the resistor R3b. The other terminal of the resistor R3b is connected to the input terminal IN.

The operation of the level shifter 140, the characteristics of the individual elements in it, and the like will be described. The constant current source CC1b operates to generate a constant current Iref and pass the constant current Iref from the node ND1b toward the ground. The constant current Iref has a predetermined fixed current value. The constant current Iref corresponds to the drain current of the transistor M1b.

The resistors Rib and R2b are resistors of the same type and have the same resistance values. The resistors R3b and R4b are resistors of the same type and have the same resistance values.

The transistors M1b to M3b constitute a current mirror circuit CM1b. The current mirror circuit CM1b has the transistor M1b disposed in the current input side and has the transistors M2b and M3b disposed in the current output side. The constant current Iref functions as the reference current in the current mirror circuit CM1b and the constant current source CC1b functions as a current source that supplies the reference current to the transistor M1b. In each of the transistors M1b, M2b, and M3b, a current corresponding to the gate-source voltage (the gate potential relative to the source potential) passes between the source and the drain.

The drain current of the transistor M2b is represented by the symbol “I1b” and the drain current of the transistor M3b is represented by the symbol “I2b”. The currents I1b and I2b can be called a first mirror current and a second mirror current respectively. The current mirror circuit CM1b produces, in the transistors M2b and M3b, the first and second mirror currents (I1b and I2b) corresponding to the reference current (Iref) passing through the transistor M1b.

The resistors Rib and R2b function as elements for converting the currents I1b and I2b into voltages. The current I1b passing through the resistor Rib produces across the resistor Rib a voltage drop that functions as the comparison voltage Vp. The current I2b passing through the resistor R2b produces across the resistor R2b a voltage drop that functions as the comparison voltage Vm.

The current mirror circuit CM1b is so configured that a current corresponding to the drain current (Iref) of the transistor M1b passes as the drain current I1b of the transistor M2b and that a current corresponding to the drain current (Iref) of the transistor M1b passes as the drain current I2b of the transistor M3b. On the assumption (for convenience' sake hereinafter referred to as the second assumption) that the resistance values of the resistors R3b and R4b are zero and no current is passing through the diode Dib, the currents I1b and I2b are each a current that is proportional to the drain current (Iref) of the transistor M1b.

Here, it is assumed that the transistors M1b to M3b are transistors that are formed on the same semiconductor substrate by the same production process and that have the same structure so that the transistors M1b to M3b have the same electric characteristics. Then, under the second assumption mentioned above, if Vout=Vin, the gate-source voltages of the transistors M1b, M2b, and M3b are equal, and thus the magnitudes of the drain currents of the transistors M1b, M2b, and M3b are equal (specifically, Iref=I1b=I2b). In this condition, the comparison voltage Vp, which corresponds to the voltage drop across the resistor Rib, and the comparison voltage Vm, which corresponds to the voltage drop across the resistor R2b, are equal.

When Vout>Vin, I1b>I2b and hence Vp>Vm. Consequently, as the gate potential of the output transistor M0 rises and the drain current of the output transistor M0 decreases, the output voltage Vout changes in the decreasing direction. By contrast, when Vout<Vin, I1b<I2b and hence Vp<Vm. Consequently, as the gate potential of the output transistor M0 falls and the drain current of the output transistor M0 increases, the output voltage Vout changes in the increasing direction. Through the operation described above, the output voltage Vout is kept at a value generally equal to the value of the input voltage Vin,

The values of the constant current Iref and the resistors Rib and R2b are designed such that the voltage (Vp) appearing across the resistor Rib and the voltage (Vm) appearing across the resistor R2b do not exceed the withstand voltage of low-withstand-voltage elements. Thus the error amplifier 200 can employ a circuit configured with low-withstand-voltage elements, and this helps achieve an effect of area saving.

The diode Dib and the resistor R3b are elements for protecting the gate voltage of the transistor M3b, and prevent the gate potential of the transistor M3b from becoming excessively higher than its source potential.

With the resistor R3b provided, the source potential of the transistor M3b is lower than the input voltage Vin by the voltage drop across the resistor R3b. The voltage drop across the resistor R3b acts as an offset voltage that has to be eliminated to achieve Vout=Vin. To cancel this offset voltage, the resistor R4b with the same resistance value as the resistor R3b is provided at the source side of the transistor M2b. Though not specifically illustrated, a resistor of the same type as and with the same resistance value as the resistors R3b and R4b can be inserted between the connection node between the output terminal OUT and the resistor R4b and the source of the transistor M1b.

The source area ratio of the transistors M1b, M2b, and M3b can be designed such that, under the second assumption mentioned above, if Vout=Vin, Iref<I1b=I2b or Iref>I1b=I2b.

### Fifth Practical Example

As mentioned earlier, the gate threshold voltages of DMOSFETs vary relatively greatly. Variations in gate threshold voltage among the transistors M1b to M3b act as an error factor in the control to keep the output voltage Vout equal to the input voltage Vin. Accordingly, modifications similar to those made to modify the configuration of the first practical example (FIG. 11) to the configuration of the second practical example (FIG. 12) can be applied to the configuration of the fourth practical example (FIG. 14). A practical example resulting from making those modifications to the configuration of the fourth practical example will now be described as a fifth practical example.

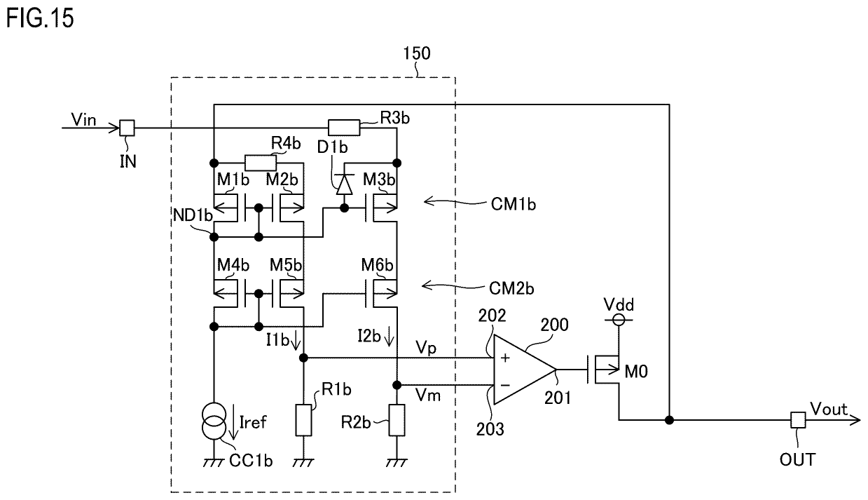

FIG. 15 is a circuit diagram of a voltage tracker 10 according to the fifth practical example. In the fifth practical example, as the level shifter 100 shown in FIG. 7, a level shifter 150 as shown in FIG. 15 is used.

The level shifter 150 is configured to further include, as compared with the level shifter 140 in the fourth practical example, transistors M4b to M6b. Moreover, in the level shifter 150, the transistors M1b to M3b are configured as low-withstand-voltage ordinary MOSFETs (ordinary MOSFETs as low-withstand-voltage elements). These differences apart, the level shifter 150 has the same configuration as the level shifter 140. Accordingly, for any features not specifically described in connection with the fifth practical example, the corresponding description of the level shifter 140 given in connection with the fourth practical example can apply to the level shifter 150.

In the level shifter 150, whereas the transistors M1b to M3b are low-withstand-voltage elements and are configured as P-channel ordinary MOSFETs, the transistors M4b to M6b are high-withstand-voltage elements and are configured as P-channel DMOSFETs. In the level shifter 150, the transistor M4b is provided between the transistor M1b and the constant current source CC1b, the transistor M5b is provided between the transistor M2b and the resistor Rib, and the transistor M6b is provided between the transistor M3b and the resistor R2b.

Specifically, in the level shifter 150, the source of the transistor M4b is connected to the drain of the transistor M1b (hence connected to the node ND1b) and, between the drain of the transistor M4b and the ground, the constant current source CC1b is provided. In the level shifter 150, the source of the transistor M5b is connected to the drain of the transistor M2b and the drain of the transistor M5b is connected to the non-inverting input terminal 202 of the error amplifier 200 and to one terminal of the resistor Rib. The other terminal of the resistor Rib is connected to the ground. In the level shifter 150, the source of the transistor M6b is connected to the drain of the transistor M3b, and the drain of the transistor M6b is connected to the inverting input terminal 203 of the error amplifier 200 and to one terminal of the resistor R2b. The other terminal of the resistor R2b is connected to the ground.

In the level shifter 150, the drain and the gate of the transistor M4b, the gate of the transistor M5b, and the gate of the transistor M6b are connected together. Thus the transistors M4b to M6b constitute a current mirror circuit CM2b. The current mirror circuit CM2b has the transistor M4b disposed in the current input side, and has the transistors M5b and M6b disposed in the current output side.

The constant current Iref (reference current) produced by the constant current source CC1b passes through the transistors M1b and M4b as the drain currents of the transistors M1b and M4b. The current I1b that passes through the resistor Rib passes through the transistors M2b and M5b as the drain currents of the transistors M2b and M5b. The current I2b that passes through the resistor R2b passes through the transistors M3b and M6b as the drain currents of the transistors M3b and M6b.

The transistors M1b to M3b are formed on the same semiconductor substrate by the same production process and have the same structure so that the transistors M1b to M3b have the same electrical characteristics. Likewise, the transistors M4b to M6b are formed on the same semiconductor substrate by the same production process and have the same structure so that the transistors M4b to M6b have the same electrical characteristics.

In the level shifter 150, owing to the transistors M1b to M3b being configured as low-withstand-voltage ordinary MOSFETs, variations in gate threshold voltage among the transistors M1b to M3b are smaller than when they are configured as DMOSFETs. This helps reduce the error factor for the control to keep the output voltage Vout equal to the input voltage Vin. Even if a high input voltage Vin (e.g., 40 V) is applied to the input terminal IN, the large part of the voltage can be born between the drain and the source of the transistors M4b to M6b configured as DMOSFETs, and thus no problem results.

### Sixth Practical Example

A sixth practical example according to the present disclosure will be described. Just as the configuration of the first practical example (FIG. 11) can be modified to the configuration of the third practical example (FIG. 13), if, in the voltage tracker 10 according to the fourth practical example, elements with a sufficiently high withstand voltage for their gate voltage can be used as the transistors M1b to M3b, those transistors can be used as the transistors M1b to M3b. In that case, no protection is needed for the gate voltage, and thus the diode Dib and the resistors R3b and R4b can be omitted.

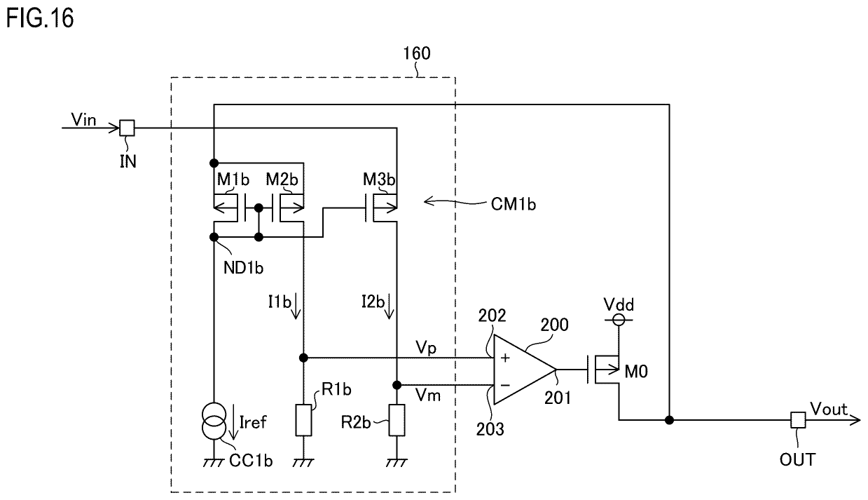

Specifically, the level shifter 140 in the fourth practical example can be modified to a level shifter 160 as shown in FIG. 16. FIG. 16 is a circuit diagram of a voltage tracker 10 according to the sixth practical example. In the sixth practical example, as the level shifter 100 shown in FIG. 7, the level shifter 160 shown in FIG. 16 is used.

Omitting the diode Dib and the resistors R3b and R4b from the level shifter 140 according to the fourth practical example yields the level shifter 160. The omission necessitates the source of the transistor M2b being directly connected to the output terminal OUT and the source of the transistor M3b being directly connected to the input terminal IN. Apart from the omission mentioned above, the level shifter 160 has the same configuration as the level shifter 140. Accordingly, for any features not specifically described in connection with the sixth practical example, the corresponding description of the level shifter 140 given in connection with the fourth practical example can apply to the level shifter 160.

Note however that, in the level shifter 160, elements with a sufficiently high withstand voltage for the gate voltage are used as the transistors M1b to M3b. Specifically, P-channel MOSFETs with a withstand voltage exceeding the input upper-limit voltage V_{HH} as their withstand voltage for the gate-source voltage are used as the transistors M1b to M3b in the level shifter 160. So long as a withstand voltage as just mentioned is obtained, in the level shifter 160, the transistors M1b to M3b can be implemented with ordinary MOSFETs or DMOSFETs.

Also with the level shifter 160, it is possible to keep the comparison voltages Vm and Vp sufficiently low; it is thus possible to achieve an effect of area reduction similar to that in the fourth practical example.

### Seventh Practical Example

A seventh practical example according to the present disclosure will be described. The seventh practical example deals with modified technologies applicable to the voltage tracker 10 described above.

The output transistor M0 can be implemented with an N-channel MOSFET. In that case, the drain of the output transistor M0 is connected to the power terminal VDD and the source of the output transistor M0 is connected to the output terminal OUT.

Moreover, for example, in the first to third practical examples (FIGS. 11 to 13), if the output transistor M0 is an N-channel MOSFET, the voltage drop appearing across the resistor R1a can be fed as the comparison voltage Vp to the non-inverting input terminal 202 and the voltage drop appearing across the resistor R2a can be fed as the comparison voltage Vm to the inverting input terminal 203. Likewise, for example, in the fourth to sixth practical examples (FIGS. 14 to 16), if the output transistor M0 is an N-channel MOSFET, the voltage drop appearing across the resistor Rib can be fed as the comparison voltage Vm to the inverting input terminal 203 and the voltage drop appearing across the resistor R2b can be fed as the comparison voltage Vp to the non-inverting input terminal 202.

In any case, if the output transistor M0 is an N-channel MOSFET, the configuration of the level shifter (110 to 160) can be modified such that, as compared with when Vout=Vin, the gate potential of the output transistor M0 falls when Vout>Vin and the gate potential of the output transistor M0 rises when Vout<Vin.

If the output transistor M0 is a P-channel MOSFET, so long as, as compared with when Vout=Vin, the gate potential of the output transistor M0 is raised when Vout>Vin and the gate potential of the output transistor M0 is lowered when Vout<Vin, the configuration of the level shifter (110 to 160) can be modified in many ways.

In the voltage tracker 10, any of the transistors described above to be configured as MOSFETs can be configured as a bipolar transistor.

For example, the first to third practical examples (FIGS. 11 to 13) allow a first modification in which the transistors M1a to M3a are configured as PNP bipolar transistors. Also in that case, as mentioned earlier, it is assumed that the transistors M1a to M3a are transistors that are formed on the same semiconductor substrate by the same production process and that have the same structure so that the transistors M1a to M3a have the same electric characteristics.

The second practical example (FIG. 12) allows a second modification in which the transistors M4a to M6a are configured as PNP bipolar transistors. Also in that case, as mentioned earlier, it is assumed that the transistors M4a to M6a are transistors that are formed on the same semiconductor substrate by the same production process and that have the same structure so that the transistors M4a to M6a have the same electric characteristics. In the second modification, the transistors M4a to M6a are formed as high-withstand-voltage elements. The second practical example (FIG. 12) can be subjected to only one of, or both of, the first and second modifications.

Likewise, for example, the fourth to sixth practical examples (FIGS. 14 to 16) allow a third modification in which the transistors M1b to M3b are configured as PNP bipolar transistors. Also in that case, as mentioned earlier, it is assumed that the transistors M1b to M3b are transistors that are formed on the same semiconductor substrate by the same production process and that have the same structure so that the transistors M1b to M3b have the same electric characteristics.

The fifth practical example (FIG. 15) allows a fourth modification in which the transistors M4b to M6b are configured as PNP bipolar transistors. Also in that case, as mentioned earlier, it is assumed that the transistors M4b to M6b are transistors that are formed on the same semiconductor substrate by the same production process and that have the same structure so that the transistors M4b to M6b have the same electric characteristics. In the fourth modification, the transistors M4b to M6b are formed as high-withstand-voltage elements. The fifth practical example (FIG. 15) can be subjected to only one of, or both of, the third and fourth modifications.

In the voltage tracker 10 of any of the practical examples, the output transistor M0 can be formed as a bipolar transistor, or as an IGBT (insulated-gate bipolar transistor).

Any transistor has a first electrode, a second electrode, and a control electrode. In a field-effect transistor, which can be a MOSFET, of the first and second electrodes one is the drain and the other is the source, and the control electrode is the gate. In an IGBT, of the first and second electrodes one is the collector and the other is the emitter, and the control electrode is the gate. In a bipolar transistor that is not classified as an IGBT, of the first and second electrodes one is the collector and the other is the emitter, and the control electrode is the base.

In the present disclosure, wherever a first physical quantity and a second physical quantity are mentioned to be “the same”, it is to be understood to allow for an error. That is, wherever a first physical quantity and a second physical quantity are mentioned to be “the same”, it means that designing or manufacturing is done with an aim of making the first and second physical quantities “the same”; thus even if in reality there is an error between the first and second physical quantities, these are to be understood to be “the same”. This applies likewise to anything other than physical quantities (e.g., it applies also to expressions such as electrical characteristics being “the same”). Terms equivalent to “the same” (e.g., “identical”, “equal”, etc.) are to be understood similarly.

Embodiments of the present disclosure can be modified in many ways as necessary without departure from the scope of the technical ideals defined in the appended claims. The embodiments described herein are merely examples of how the present invention can be implemented, and what is meant by any of the terms used to describe the present invention and its constituent elements is not limited to that mentioned in connection with the embodiments. The specific values mentioned in the above description are merely illustrative and needless to say can be modified to different values.

### NOTES

To follow are notes on the present disclosure of which specific configuration examples have been described above by way of embodiments.

According to one aspect of the present disclosure, a power supply device (10; see FIG. 7) includes: an input terminal (IN) configured to receive an input voltage (Vin); an output terminal (OUT) configured to have an output voltage (Vout) applied to it; a power terminal (VDD) configured to receive a supply voltage (Vdd); an output transistor (M0) provided between the power terminal and the output terminal; a level shifter (100; 110, 120, 130, 140, 150, or 160) configured to generate two comparison voltages (Vp, Vm) by shifting the levels of the input voltage and the output voltage to lower potentials; and an amplifier circuit (200) configured to control the state of the output transistor based on the magnitude relationship between the two comparison voltages. (A first configuration.)

With this configuration, even if the input voltage and the output voltage are high, it is possible to form the amplifier circuit with low-withstand-voltage elements, and thereby to achieve size reduction in the amplifier circuit and the power supply circuit (space saving in a circuit formed with a semiconductor integrated circuit).

In the power supply circuit of the first configuration described above, the level shifter (110, 120, 130, 140, 150, or 160) can include a current mirror circuit (CM1a or CM1b) and generate the two comparison voltages from the input voltage and the output voltage by use of the current mirror circuit. (A second configuration.)

Through level-shifting using a current mirror circuit, it is possible to generate comparison voltages that can be handled with low-withstand-voltage elements.

In the power supply circuit of the second configuration described above, the level shifter can generate two currents (I1a and I2a, or I1b and I2b) corresponding to the input voltage and the output voltage by use of the current mirror circuit and, by converting the two currents into voltages, generate the two comparison voltages. (A third configuration.)

In this way it is possible to generate with a simple configuration the two comparison voltages that can be handled with low-withstand-voltage elements.

In the power supply circuit of the third configuration described above, the current mirror circuit can include a first transistor, a second transistor, and a third transistor (M1a to M3a, or M1b to M3b) having their control terminals connected together and, in accordance with a reference current (Iref) passing through one of the first, second, and third transistors, generate as the two currents a first mirror current and a second mirror current in the other two transistors. (A fourth configuration.)

In this way it is possible to generate with a simple configuration the two comparison voltages that can be handled with low-withstand-voltage elements.

In the power supply circuit of the fourth configuration described above (see FIGS. 11 to 13), the two comparison voltages can be a first comparison voltage and a second comparison voltage. The level shifter (110, 120, or 130) can further include: a current source (CC1a) configured to supply the first transistor with the reference current; a first resistor (R1a) configured to convert the first mirror current into the first comparison voltage; and a second resistor (R2a) configured to convert the second mirror current into the second comparison voltage. The first transistor can be provided between the input terminal and the current source, the second transistor can be provided between the input terminal and the first resistor, and the third transistor can be provided between the output terminal and the second resistor. (A fifth configuration.)

In this way it is possible to generate with a simple configuration the two comparison voltages that can be handled with low-withstand-voltage elements.

In the power supply circuit of the fifth configuration described above (see FIGS. 11 and 12), the first to third transistors can each have a first electrode, a second electrode, and a control electrode. In each of the first to third transistors, a current according to the voltage between the control electrode and the first electrode can pass between the first and second electrodes. The level shifter can further include: a diode (D1a) provided between the control electrode and the first electrode of the third transistor so as to have a forward direction pointing from the control electrode to the first electrode of the third transistor; a third resistor (R3a) provided between the first electrode of the third transistor and the output terminal; and a fourth resistor (R4a) provided between the first electrode of the second transistor and the input terminal. (A sixth configuration.)

With this configuration, it is possible to prevent an excessively high voltage from being applied between the control electrode and the first electrode of the third transistor. It is thus possible to form the current mirror circuit by using elements with a low withstand voltage for the voltage at the control electrode.

In the power supply circuit of the sixth configuration described above (see FIG. 12), the level shifter can further include: a fourth transistor (M4a) provided between the first transistor and the current source; a fifth transistor (M5a) provided between the second transistor and the first resistor; and a sixth transistor (M6a) provided between the third transistor and the second resistor. The fourth, fifth, and sixth transistors can have their control electrodes connected together to constitute a second current mirror circuit (CM2a). The second current mirror circuit can have the fourth transistor disposed in the current input side and the fifth and sixth transistors disposed in the current output side. The reference current can pass through the first and fourth transistors, the first current can pass through the second and fifth transistors, and the second current can pass through the third and sixth transistors. (A seventh configuration.)

With this configuration, it is possible to form the first to third transistors with low-withstand-voltage elements. This helps reduce variations in electrical characteristics (e.g., gate threshold voltage) among the first to third transistors and thereby achieve the desired control in the power supply device.

In the power supply circuit of the fourth configuration described above (see FIGS. 14 to 16), the two comparison voltages (Vp, Vm) can be a first comparison voltage and a second comparison voltage. The level shifter (140, 150, or 160) can further include: a current source (CC1b) configured to supply the first transistor with the reference current; a first resistor (Rib) configured to convert the first mirror current into the first comparison voltage; and a second resistor (R2b) configured to convert the second mirror current into the second comparison voltage. The first transistor can be provided between the output terminal and the current source, the second transistor can be provided between the output terminal and the first resistor, and the third transistor can provided between the input terminal and the second resistor. (An eighth configuration.)

In this way it is possible to generate with a simple configuration the two comparison voltages that can be handled with low-withstand-voltage elements.

In the power supply circuit of the eighth configuration described above (see FIGS. 14 and 15), the first to third transistors can each have a first electrode, a second electrode, and a control electrode. In each of the first to third transistors, a current according to the voltage between the control electrode and the first electrode can pass between the first and second electrodes. The level shifter can further include: a diode (D1b) provided between the control electrode and the first electrode of the third transistor so as to have a forward direction pointing from the control electrode to the first electrode of the third transistor; a third resistor (R3b) provided between the first electrode of the third transistor and the input terminal; and a fourth resistor (R4b) provided between the first electrode of the second transistor and the output terminal. (A ninth configuration.)

With this configuration, it is possible to prevent an excessively high voltage from being applied between the control electrode and the first electrode of the third transistor. It is thus possible to form the current mirror circuit by using elements with a low withstand voltage for the voltage at the control electrode.

In the power supply circuit of the ninth configuration described above (FIG. 15), the level shifter can further include: a fourth transistor (M4b) provided between the first transistor and the current source; a fifth transistor (M5b) provided between the second transistor and the first resistor; and a sixth transistor (M6b) provided between the third transistor and the second resistor. The fourth, fifth, and sixth transistors can have their control electrodes connected together to constitute a second current mirror circuit (CM2b). The second current mirror circuit can have the fourth transistor disposed in the current input side and the fifth and sixth transistors disposed in the current output side. The reference current can pass through the first and fourth transistors, the first current can pass through the second and fifth transistors, and the second current can pass through the third and sixth transistors. (A tenth configuration.)

With this configuration, it is possible to form the first to third transistors with low-withstand-voltage elements. This helps reduce variations in electrical characteristics (e.g., gate threshold voltage) among the first to third transistors and thereby achieve the desired control in the power supply device.

In the power supply circuit of any of the first to tenth configurations described above, the power supply device can be a voltage tracker, and the state of the output transistor be controlled based on the magnitude relationship between the two comparison voltages so as to reduce the difference between the output voltage and the input voltage. (An eleventh configuration.)

1. A power supply device comprising:
an input terminal configured to receive an input voltage;
an output terminal configured to have an output voltage applied thereto;
a power terminal configured to receive a supply voltage;
an output transistor provided between the power terminal and the output terminal;
a level shifter configured to generate two comparison voltages by shifting levels of the input voltage and the output voltage to lower potentials; and
an amplifier circuit configured to control a state of the output transistor based on a magnitude relationship between the two comparison voltages.

2. The power supply device according to claim 1, wherein
the level shifter includes a current mirror circuit and generates the two comparison voltages from the input voltage and the output voltage by use of the current mirror circuit.

3. The power supply device according to claim 2, wherein
the level shifter generates two currents corresponding to the input voltage and the output voltage by use of the current mirror circuit and, by converting the two currents into voltages, generates the two comparison voltages.

4. The power supply device according to claim 3, wherein
the current mirror circuit includes a first transistor, a second transistor, and a third transistor having control terminals thereof connected together and, in accordance with a reference current passing through one of the first, second, and third transistors, generates as the two currents a first mirror current and a second mirror current in the other two transistors.

5. The power supply device according to claim 4, wherein
the two comparison voltages are a first comparison voltage and a second comparison voltage,
the level shifter further includes:
a current source configured to supply the first transistor with the reference current;
a first resistor configured to convert the first mirror current into the first comparison voltage; and
a second resistor configured to convert the second mirror current into the second comparison voltage, and
the first transistor is provided between the input terminal and the current source, the second transistor is provided between the input terminal and the first resistor, and the third transistor is provided between the output terminal and the second resistor.

6. The power supply device according to claim 5, wherein
the first to third transistors each have a first electrode, a second electrode, and a control electrode,
in each of the first to third transistors, a current according to a voltage between the control electrode and the first electrode passes between the first and second electrodes,
the level shifter further includes:
a diode provided between the control electrode and the first electrode of the third transistor so as to have a forward direction pointing from the control electrode to the first electrode of the third transistor;
a third resistor provided between the first electrode of the third transistor and the output terminal; and
a fourth resistor provided between the first electrode of the second transistor and the input terminal.

7. The power supply device according to claim 6, wherein
the level shifter further includes:
a fourth transistor provided between the first transistor and the current source;
a fifth transistor provided between the second transistor and the first resistor; and
a sixth transistor provided between the third transistor and the second resistor,
the fourth, fifth, and sixth transistors have control electrodes thereof connected together to constitute a second current mirror circuit, the second current mirror circuit having the fourth transistor disposed in a current input side and the fifth and sixth transistors disposed in a current output side,
the reference current passes through the first and fourth transistors, the first current passes through the second and fifth transistors, and the second current passes through the third and sixth transistors.

8. The power supply device according to claim 4, wherein
the two comparison voltages are a first comparison voltage and a second comparison voltage,
the level shifter further includes:
a current source configured to supply the first transistor with the reference current;
a first resistor configured to convert the first mirror current into the first comparison voltage; and
a second resistor configured to convert the second mirror current into the second comparison voltage,
the first transistor is provided between the output terminal and the current source, the second transistor is provided between the output terminal and the first resistor, and the third transistor is provided between the input terminal and the second resistor.

9. The power supply device according to claim 8, wherein
the first to third transistors each have a first electrode, a second electrode, and a control electrode,
in each of the first to third transistors, a current according to a voltage between the control electrode and the first electrode passes between the first and second electrodes,
the level shifter further includes:
a diode provided between the control electrode and the first electrode of the third transistor so as to have a forward direction pointing from the control electrode to the first electrode of the third transistor;
a third resistor provided between the first electrode of the third transistor and the input terminal; and
a fourth resistor provided between the first electrode of the second transistor and the output terminal.

10. The power supply device according to claim 9, wherein
the level shifter further includes:
a fourth transistor provided between the first transistor and the current source;
a fifth transistor provided between the second transistor and the first resistor; and
a sixth transistor provided between the third transistor and the second resistor,
the fourth, fifth, and sixth transistors have control electrodes thereof connected together to constitute a second current mirror circuit, the second current mirror circuit having the fourth transistor disposed in a current input side and the fifth and sixth transistors disposed in a current output side,
the reference current passes through the first and fourth transistors, the first current passes through the second and fifth transistors, and the second current passes through the third and sixth transistors.

11. The power supply device according to claim 1, wherein
the power supply device is a voltage tracker, and
the state of the output transistor is controlled based on the magnitude relationship between the two comparison voltages so as to reduce a difference between the output voltage and the input voltage.
